(19) United States
(12) Patent Application Publication
(10) Pub. No.: US 2016/0108858 A1
(43) Pub. Date: Apr. 21, 2016

(54) CONTROL APPARATUS AND CONTROL METHOD FOR INTERNAL COMBUSTION ENGINE

(71) Applicants: Hideki Miyahara, Toyota-shi, Aichi-ken (JP); Kenichiro KAWASE, Toyota-shi, Aichi-ken (JP)

(72) Inventors: Hideki MIYAHARA, Miyoshi-shi (JP); Kenichiro KAWASE, Okazaki-shi (JP)

(73) Assignee: TOYOTA JIDOSHA KABUSHIKI KAISHA, Toyota-shi, Aichi-ken (JP)

(21) Appl. No.: 14/892,145

(22) PCT Filed: May 16, 2014
(86) PCT No.: PCT/IB14/00750

§ 371 Date: Nov. 18, 2015

(30) Foreign Application Priority Data
May 20, 2013 (JP) 2013-105989

(51) Int. Cl. F02M 25/07; F02D 41/00

(52) U.S. Cl. CPC F02M 25/0702; F02M 25/0771; F02M 25/0754; F02M 25/0717; F02M 25/072; F02D 41/0077

(57) ABSTRACT

An ECU opens/closes an EGR valve (43) at a predetermined time (PI) to start blockage detection of an exhaust gas recirculation passage, increases an opening degree of a throttle valve (25) after start of the blockage detection over an opening degree immediately before the start of the blockage detection, and detects a blocking amount of the exhaust gas recirculation passage based on a change amount (ΔGN) in an internal pressure detected by a pressure sensor, which is a difference between the internal pressure detected when the EGR valve is opened and the internal pressure detected when the EGR valve is closed.

### BACKGROUND OF THE INVENTION

1. Field of the Invention

The invention relates to a control apparatus for an internal combustion engine.

2. Description of Related Art

An internal combustion engine (hereinafter referred to also as an engine) that is mounted on an automobile or the like may be provided with an exhaust gas recirculation device (hereinafter referred to also as an EGR device) in order to reduce nitrogen oxides (NOx) contained in exhaust gas that is discharged from combustion chambers.

For such an EGR device, there has been proposed a control apparatus for an internal combustion engine that outputs a warning through the lighting or the like of a malfunction indicator lamp (an MIL) to prompt replacement of the EGR device if the blockage level of an EGR passage has become larger than a permissible value, for example, if the blockage level has become large enough for exhaust gas to exceed an onboard diagnosis (OBD) regulation value (e.g., see Japanese Patent Application Publication No. 2010-031750 (JP-2010-031750 A).

### SUMMARY OF THE INVENTION

On the other hand, when detecting the blockage of an EGR passage in recent years, for example, detecting the blockage of an EGR passage as made compulsory by the European OBD legislation, a malfunction is not completely detected. Therefore, control apparatuses for internal combustion engines with higher detection accuracy have been desired.

The invention provides a control apparatus for an internal combustion engine that can enhance the accuracy in detecting the blockage that has occurred in an exhaust gas recirculation passage.

A control apparatus for an internal combustion engine that includes an intake passage and an exhaust passage according to a first aspect of the invention includes a throttle valve, an exhaust gas recirculation passage, an EGR valve, a pressure sensor, and an electronic control unit. The throttle valve is arranged in the intake passage to increase/reduce an amount of intake air flowing through the intake passage. The exhaust gas recirculation passage provides fluid communication between the exhaust passage and a region of the intake passage that is located downstream of the throttle valve. The EGR valve is arranged in the exhaust gas recirculation passage to control an amount of exhaust gas recirculated from the exhaust passage to the intake passage. The pressure sensor is configured to detect an internal pressure of the intake passage downstream of a connection portion between the intake passage and the exhaust gas recirculation passage. The electronic control unit is configured to: (a) control the EGR valve to increase/reduce a flow amount of recirculated gas, (b) detect a blockage level of the exhaust gas recirculation passage based on a change amount in the internal pressure detected by the pressure sensor, the change amount being a difference between the internal pressure detected when the flow amount of recirculated gas is increased and the internal pressure detected when the flow amount of recirculated gas is reduced, (c) control the EGR valve at a predetermined time to increase/reduce the flow amount of recirculated gas, and start blockage detection of the exhaust gas recirculation passage, and (d) increase an opening degree of the throttle valve after start of the blockage detection over an opening degree immediately before the start of the blockage detection.

With this configuration, when the flow amount of recirculated gas is increased/reduced to start blockage detection of the exhaust gas recirculation passage at the predetermined time, the opening degree of the throttle valve can be increased in an opening direction. Accordingly, a detection value of the blockage that has occurred in the exhaust gas recirculation passage emerges more significantly to an extent corresponding to the increase in the opening degree of the throttle valve. Therefore, the accuracy in detecting the blockage that has occurred in the exhaust gas recirculation passage can be made higher than before.

In the control apparatus for the internal combustion engine according to the aforementioned aspect of the invention, the electronic control unit may be configured to detect blockage level of the exhaust gas recirculation passage based on a change amount in the internal pressure detected by the pressure sensor, which is a difference between the internal pressure detected when the EGR valve is opened and the internal pressure detected when the EGR valve is closed.

With this configuration, when the blockage detection of the exhaust gas recirculation passage is started on the basis of the change amount in the internal pressure upon the opening/closing of the EGR valve at the predetermined time, the opening degree of the throttle valve can be increased in the opening direction. Accordingly, a detection value of the blockage that has occurred in the exhaust gas recirculation passage emerges more significantly to an extent corresponding to the increase in the opening degree of the throttle valve. Therefore, the accuracy in detecting the blockage that has occurred in the exhaust gas recirculation passage can be made high.

In the control apparatus for the internal combustion engine according to the aforementioned aspect of the invention, the electronic control unit may be configured to return the opening degree of the throttle valve to an original value after a lapse of a predetermined time from the start of the blockage detection.

With this configuration, an imbalanced state resulting from a change in the amount of intake air at the time when the throttle valve is opened to start the blockage detection can be made to last only for a short period.

In the control apparatus for the internal combustion engine according to the aforementioned aspect of the invention, the electronic control unit may be configured to increase the opening degree of the throttle valve in comparison with the opening degree immediately before start of the blockage detection only during a period in which the EGR valve is open after start of the blockage detection.

With this configuration, the times for opening/closing the respective valves in the blockage detection can be synchronized with each other.

In the control apparatus for the internal combustion engine according to the aforementioned aspect of the invention, the electronic control unit may be configured to, at the predetermined time, start the blockage detection independently of opening/closing control of the EGR valve for recirculating exhaust gas from the exhaust passage to the intake passage, the predetermined time occurring when an engine rotational speed of the internal combustion engine reaches a value equal to or lower than a predetermined rotational speed.

Owing to this configuration, the predetermined time for starting blockage detection can be realized as a time that is unlikely to adversely influence the operation of the internal combustion engine.

A control method for a control apparatus according to a second aspect of the invention includes the following steps, namely, (a) controlling, by an electronic control unit, an EGR valve to increase/reduce a flow amount of recirculated gas, (b) detecting, by an electronic control unit, a blockage level of an exhaust gas recirculation passage based on a change amount in an internal pressure detected by a pressure sensor, the change amount being a difference between, the internal pressure detected when the flow amount of recirculated gas is increased and the internal pressure detected when the flow amount of recirculated gas is reduced, (c) controlling the EGR valve at a predetermined time to increase/reduce the flow amount of recirculated gas, and starting blockage detection of the exhaust gas recirculation passage, by the electronic control unit, and (d) increasing, by the electronic control unit, an opening degree of a throttle valve after start of the blockage detection over an opening degree immediately before the start of the blockage detection.

The invention makes it possible to provide a control apparatus and a control method for an internal combustion engine that can enhance the accuracy in detecting the blockage that has occurred in an exhaust gas recirculation passage.

### BRIEF DESCRIPTION OF THE DRAWINGS

Features, advantages, and technical and industrial significance of an exemplary embodiment of the invention will be described below with reference to the accompanying drawings, in which like numerals denote like elements, and wherein:

FIG. 1 is an illustrative view of an overall configuration of a control apparatus for an internal combustion engine according to the embodiment of the invention;

FIG. 2 is a graphic view of a result of an evaluation of a relationship between a regulation value (an axis of ordinate) and a maximum limited EGR flow amount with the blockage of an EGR passage reproduced) in the control apparatus for the internal combustion engine according to the embodiment of the invention;

FIG. 3 is a graphic view showing a relationship between times for opening/closing respective valves and a ΔGN value in the control apparatus for the internal combustion engine according to the embodiment of the invention; and

FIG. 4 is a graphic view showing a relationship between the ΔGN value in a case where an opening degree of a throttle valve is left unchanged from a value at the start of blockage detection and the ΔGN value in a case where the throttle valve is opened, in the control apparatus for the internal combustion engine according to the embodiment of the invention.

### DETAILED DESCRIPTION OF EMBODIMENT

The embodiment of the invention will be described hereinafter with reference to the drawings.

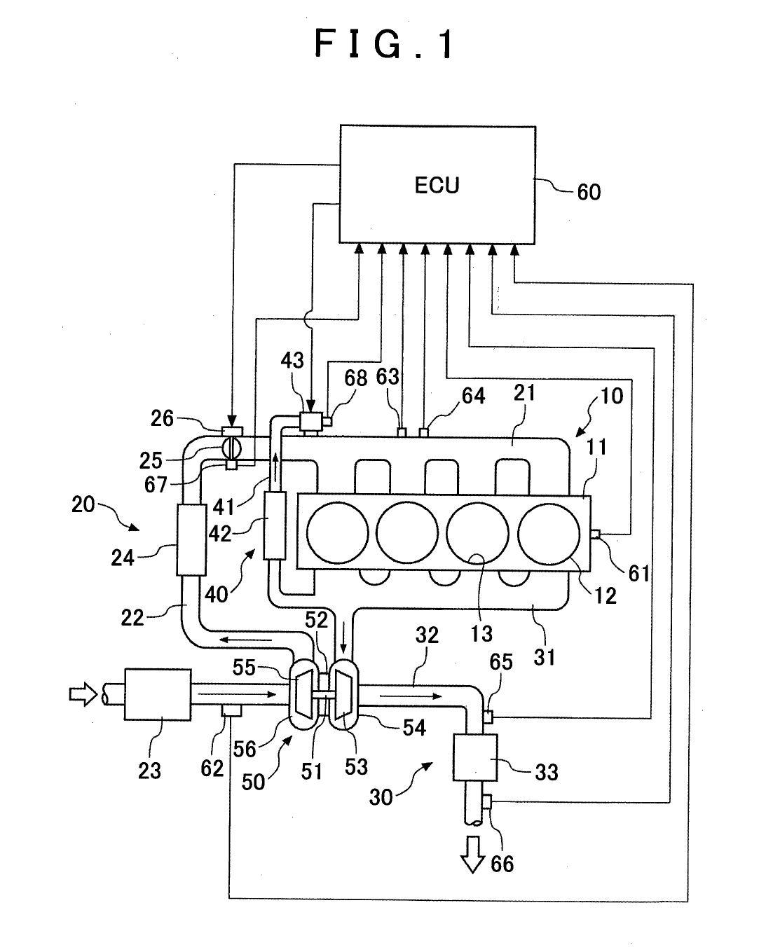

First of all, a configuration will be described. As shown in FIG. 1, an engine 10 as an internal combustion engine according to this embodiment of the invention is an in-line four-cylinder gasoline engine as an example of the internal combustion engine according to the invention, and functions as a motive power source of an automobile (not shown) or the like.

As shown in FIG. 1, the engine 10 is equipped with a cylinder head 11 and a cylinder block (not shown). This cylinder head 11 and this cylinder block form four cylinders 12. The cylinders 12 and pistons (not shown) define combustion chambers 13 respectively. Besides, although not shown in the drawing, an intake port for introducing outside air into the combustion chambers 13 and an exhaust port for discharging exhaust gas from the combustion chambers 13 are formed in the cylinder head 11.

Thus, the engine 10 has an intake passage 20 through which air is sucked into the combustion chambers 13 via the intake port, and an exhaust passage 30 through which exhaust gas is discharged from the combustion chambers 13 via the exhaust port, across the combustion chambers 13. Besides, the engine 10 has an exhaust gas recirculation passage 40 (hereinafter referred to also as an EGR passage) through which part of exhaust gas from the respective combustion chambers 13 is recirculated from a midway portion of the exhaust passage 30 to a midway portion of the intake passage 20. Furthermore, the engine 10 has a turbocharger 50 that compresses air in the intake passage 20 through the use of the energy of exhaust gas in the exhaust passage 30 to supercharge the respective combustion chambers 13 with air.

The intake passage 20 has an intake manifold 21, an intake pipe 22 that communicates with an upstream side of the intake manifold 21, an air cleaner 23 that purifies intake air, an intercooler 24 that cools intake air, and a throttle valve 25 that makes an adjustment to increase/reduce the amount of intake air.

The throttle valve 25 has, at one end of a valve shaft thereof, a throttle motor 26 as an actuator for driving the throttle valve 25. The throttle valve 25 in this embodiment of the invention is an electronically controlled throttle that is driven to be opened/closed by the throttle motor 26.

The exhaust passage 30 has an exhaust manifold 31 that communicates with the combustion chambers 13, an exhaust pipe 32 that communicates with a downstream side of the exhaust manifold 31, and a catalytic device 33 that purifies exhaust gas from the respective combustion chambers 13.

The catalytic device 33 is provided downstream of the turbocharger 50. Although not shown in the drawing, the catalytic device 33 has a catalyst that purifies exhaust gas discharged from the combustion chambers 13, and a heater that electrically heats this catalyst. The catalytic device 33 is supplied with electric power from, for example, an in-vehicle battery (not shown).

The EGR passage 40 has an EGR pipe 41, an EGR cooler 42 that cools recirculated exhaust gas, and an EGR valve 43 that makes an adjustment to increase/reduce the amount of exhaust gas recirculated to the intake passage 20. The EGR pipe 41 provides fluid communication between the exhaust passage 30 and a region of the intake passage 20 that is located downstream of the throttle valve 25.

In this embodiment of the invention, the EGR pipe 41 bypasses the combustion chambers 13 to provide fluid communication between the exhaust manifold 31 and the intake manifold 21, and allows exhaust gas from the respective combustion chambers 13 to be recirculated.

The turbocharger 50 has a center housing 52 that rotatably supports a coupling shaft 51, a turbine housing 54 in which a turbine wheel 53 is accommodated, and a compressor housing 56 in which a compressor impeller 55 is accommodated.

The turbine wheel 53 is attached to one end of the coupling shaft 51 of the center housing 52, and the compressor impeller 55 is attached to the other end of the coupling shaft 51. The coupling shaft 51 rotates this turbine wheel 53 and this compressor impeller 55 integrally with each other.

In the turbocharger 50, the turbine wheel 53 rotates through the use of the energy of exhaust gas, and the compressor impeller 55 rotates as a result. Then, intake air is supercharged through rotation of the compressor impeller 55, and supercharged air is forcibly delivered to the respective combustion chambers 13.

The engine 10 according to this embodiment of the invention has a coolant temperature sensor 61, an air flow meter 62, an intake air temperature sensor 63, a pressure sensor 64, an A/F sensor 65, an exhaust gas temperature sensor 66, a throttle opening degree sensor 67, and an EGR valve sensor 68. Incidentally, although not shown in the drawing, the engine 10 has, in addition to these various sensors, an accelerator opening degree sensor, an engine rotational speed sensor, a vehicle speed sensor, and the like. The engine 10 outputs to an ECU 60 signals indicating detection results of those sensors.

The coolant temperature sensor 61 outputs to the ECU 60 a detection signal corresponding to a coolant temperature THW of the engine 10. Incidentally, in FIG. 1, the coolant temperature sensor 61 is attached to the cylinder head 11. In fact, however, the coolant temperature sensor 61 is arranged in a water jacket that is formed in the cylinder head 11.

The air flow meter 62 is arranged upstream of the throttle valve 25, and outputs to the ECU 60 a detection signal corresponding to an amount of intake air.

The intake air temperature sensor 63 is arranged in the intake manifold 21, and outputs to the ECU 60 a detection signal corresponding to a temperature of intake air. The pressure sensor 64 is arranged in the intake manifold 21, and outputs to the ECU 60 a detection signal corresponding to an internal pressure.

The A/F sensor 65 is arranged upstream of the catalytic device 33, and outputs to the ECU 60 a detection signal corresponding to a concentration of oxygen in exhaust gas (an exhaust gas A/F). The exhaust gas temperature sensor 66 is arranged downstream of the catalytic device 33, and outputs to the ECU 60 a detection signal corresponding to a temperature of exhaust gas.

The throttle opening degree sensor 67 outputs to the ECU 60 a detection signal corresponding to an opening degree of the throttle valve 25. The EGR valve sensor 68 outputs to the ECU 60 a detection signal corresponding to an opening degree of the EGR valve 43.

Incidentally, the accelerator opening degree sensor outputs to the ECU 60 a detection signal corresponding to a depression amount of an accelerator pedal. The engine rotational speed sensor detects a rotational speed of a crankshaft of the engine 10, and outputs the detected rotational speed to the ECU 60 as an engine rotational speed. The vehicle speed sensor detects a rotational speed of wheels, and outputs the detected rotational speed to the ECU 60 as a speed signal indicating a vehicle speed.

Although not shown in the drawing, the ECU 60 has a CPU, a ROM, a RAM, a backup RAM, and the like.

Various control programs including programs for performing exhaust gas recirculation amount control and later-described foreign matter detection control, and a control program for controlling the fuel injection amount for the cylinders 12, and maps and the like that are referred to in executing these various control programs are stored in the ROM.

The CPU performs various calculation processes on the basis of the various control programs and maps stored in the ROM. Besides, the RAM temporarily stores a calculation result obtained by the CPU, data input from the aforementioned respective sensors, and the like. The backup RAM is constituted by a non-volatile memory, and stores, for example, data and the like that should be saved when the engine 10 is stopped. Incidentally, the ECU 60 performs known control as far as various kinds of control other than the blockage detection according to the invention are concerned, and detailed description thereof is hence omitted herein.

Then, the ECU 60 performs various kinds of control of the engine 10 including exhaust gas recirculation amount control, blockage detection control and the like, on the basis of outputs of the aforementioned various sensors.

A concrete control example of the ECU 60 that constitutes a blockage control apparatus according to the embodiment of the invention will be described hereinafter.

First of all, in the embodiment of the invention, the blockage of the interior of a passage resulting from deposition of deposits such as soot, unburned fuel and the like in the EGR passage 40 is detected. In this process, the ECU 60 detects internal pressures of the intake manifold 21 in a case where the EGR valve 43 is opened and a case where the EGR valve 43 is closed with the aid of the pressure sensor 64, and detects the blockage of the EGR passage 40 on the basis of a change amount (ΔGN) therebetween.

It should be noted herein that the detection criterion has exceeded an OBD regulation value since Euro 5 when, for example, detecting the blockage of the EGR passage 40 as made compulsory by the European OBD legislation, and that a malfunction is therefore not completely detected.

Accordingly, if the regulation is further strengthened in the future, it may become necessary to provide a blockage control apparatus that detects a smaller level of blockage than the blockage control apparatus in the engine corresponding to Euro 5, in the case of, for example, Euro 6 that is to be fully applied from September, 2015.

In this case, it may be impossible to detect a predetermined level of blockage unless an S/N value between the time of normality and the time of abnormality, namely, the time of the occurrence of blockage is sufficiently ensured.

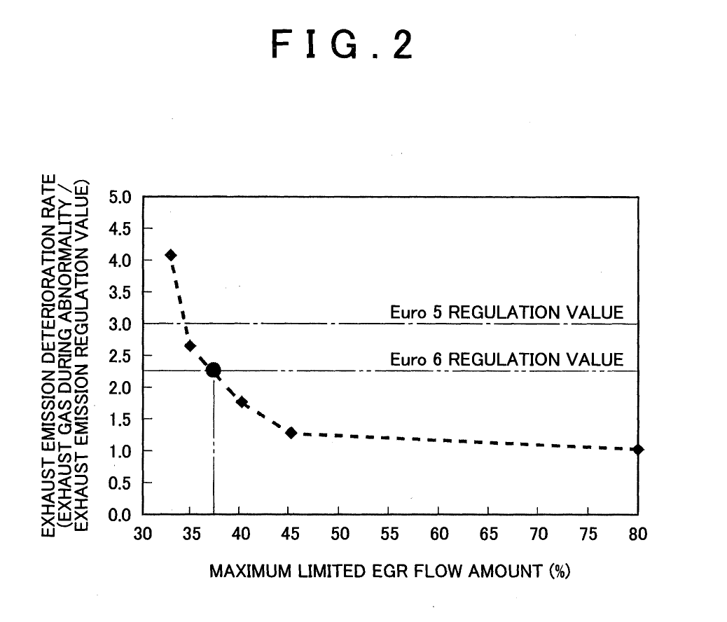

More specifically, as shown in FIG. 2, a smaller level of blockage must be detected in the case of a regulation that will be strengthened in Euro 6 with respect to the regulation at the time of Euro 5.

Thus, in this embodiment of the invention, the opening degree of the throttle valve 25 at the time when the EGR valve 43 is forcibly driven during normal traveling is fixed according to needs for the adaptation of engine exhaust gas. For example, the ECU 60 controls the throttle valve 25 to a set value on a closed side, with a view to preventing the temperature of exhaust gas from falling during warm-up.

On the other hand, the ECU 60 starts blockage detection on the condition that the vehicle be decelerated during idling as a predetermined time as well, namely, that the engine rotational speed of the engine 10 have reached a value equal to or lower than a predetermined rotational speed (e.g., 700 to 800 rpm). That is, the predetermined time when the blockage detection is started is realized as a most appropriate time that is unlikely to have an adverse influence during the operation of the engine 10.

Upon starting the blockage detection, the ECU 60 controls the throttle motor 26 toward an open side such that the opening degree of the throttle valve 25 immediately before the start of detection becomes advantageous as to the accuracy in detecting the blockage, and makes the ΔGN value mainly during normality more significant.

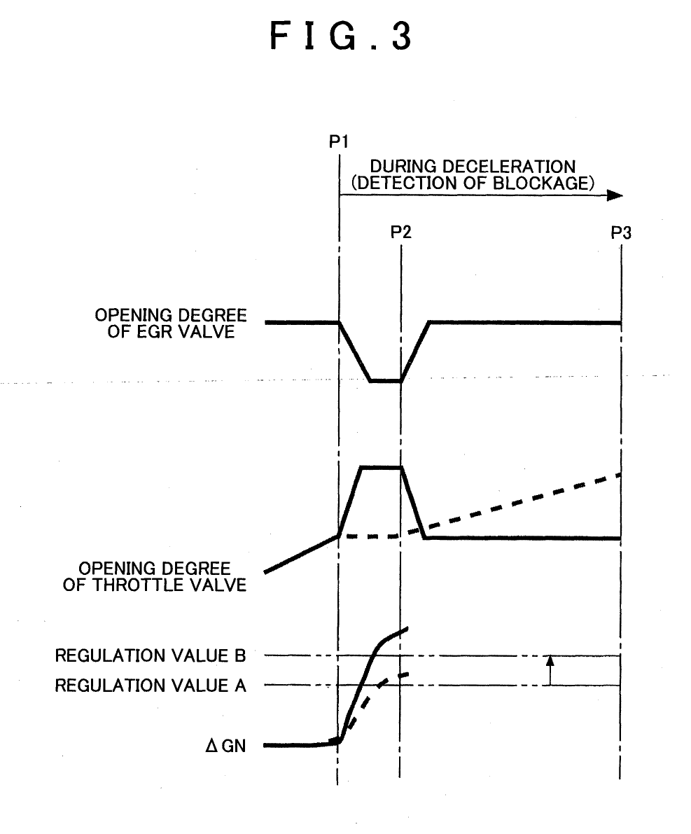

More specifically, as shown in FIG. 3, upon detecting that the vehicle is decelerated (at a point P1), the ECU 60 forcibly closes the EGR valve 43 independently of a controlled state during deceleration, and at the same time, increases the opening degree of the throttle valve 25 in an opening direction. The ECU 60 then acquires the ΔGN value at that time, and stores the acquired value into the RAM or the like.

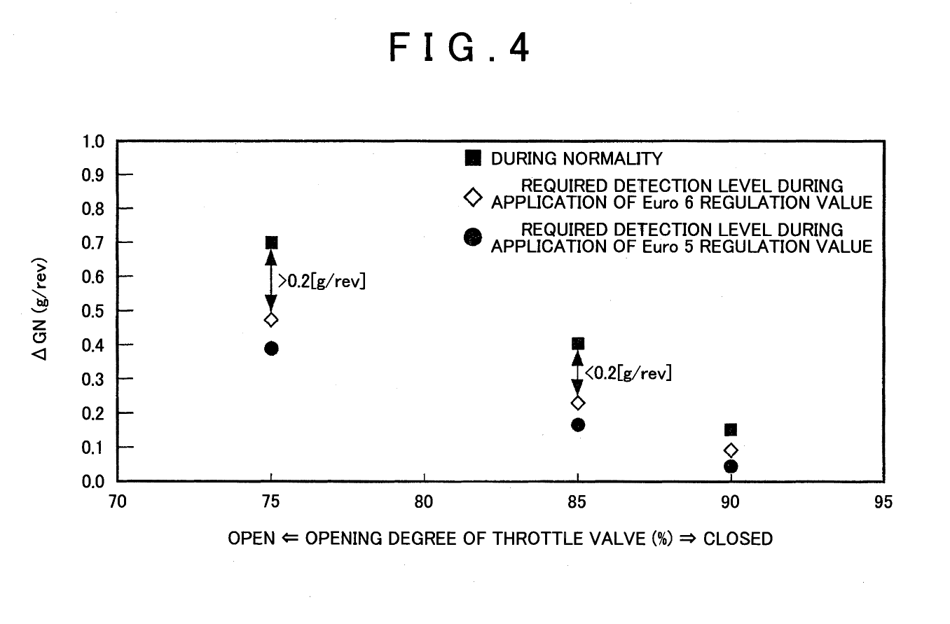

Incidentally, when increasing the opening degree of the throttle valve 25 in the opening direction in comparison with the opening degree immediately before the start of the blockage detection, the ECU 60 performs opening control to such an opening degree that the ΔGN value emerges more significantly. More specifically, as shown in FIG. 4, if the opening degree of the throttle valve 25 at a time point indicated by the point P1 when it is detected that the vehicle is decelerated is 85% in a closing direction (15% in the opening direction), the ECU 60 sets the opening degree to 75% in the closing direction (25% in the opening direction).

Then, upon acquiring the internal pressure at the time when the EGR valve 43 is closed (at a point P2), the ECU 60 returns the opening degrees of the EGR valve 43 and the throttle valve 25 to their original values, and acquires the internal pressure at the time when the EGR valve 43 is opened (at a point P3).

Furthermore, the ECU 60 makes a comparison between the internal pressure at the time when the EGR valve 43 is closed and the internal pressure at the time when the EGR valve 43 is opened to calculate a change amount in the pressure (ΔGN), determines, from the change amount in the pressure (ΔGN), whether or not the blockage has occurred, and ends the blockage detection (at the point P3). It should be noted herein that the times for opening/closing the respective valves 25 and 43 during the blockage detection are synchronized with each other.

Then, if it is determined as a result of the blockage detection that the EGR passage 40 is blocked, the ECU 60 outputs a warning through, for example, the lighting of the MIL or the like.

In this manner, in this embodiment of the invention, a regulation value A at which the throttle valve 25 is left unchanged in calculating the ΔGN value after closing the EGR valve 43 as is the case with conventional blockage detection indicated-by dotted lines in FIG. 3 can be raised to a regulation value B.

Thus, as shown in FIG. 4, while the difference in the change amount ΔGN in the internal pressure between the ΔGN value that is calculated at the time of normality with the opening degree of the throttle valve 25 equal to 85% in the closing direction and the ΔGN value of the regulation value (a required detection level) is equal to or smaller than 0.2 (g/rev), a value equal to or larger than 0.2 (g/rev) can be ensured.

In this manner, if the opening degree of the throttle valve 25 is increased in the opening direction, the ΔGN value becomes more significant. Accordingly, since the difference in the ΔGN value becomes clear in determining whether EGR is abnormal due to blockage or normal, the ECU 60 can enhance the accuracy in the blockage detection.

Besides, after the lapse of a predetermined time from the start of blockage detection, the ECU 60 controls the throttle motor 26 in such a manner as to return the opening degree of the throttle valve 25 toward its original value by the increase. That is, there is a need to suck air as usual even during deceleration of the vehicle. From the standpoint of the balance of combustion or the like, it is not preferable that the opening degree of the throttle valve 25 have been increased to the open state for a long time.

Accordingly, the ECU 60 performs control to the valve opening degree for blockage detection, only during a period in which the pressure sensor 64 can detect internal pressures of the intake manifold 21 in the case where the EGR valve 43 is opened and the case where the EGR valve 43 is closed to detect the blockage.

Thus, an imbalanced state resulting from a change in the amount of intake air in the intake passage 20 at the time when the throttle valve 25 is opened to start the blockage detection can be made to last only during a short period. Accordingly, the possibility of the occurrence of a combustion failure or the like and a feeling of discomfort imparted to a driver, which are caused by imbalance of the amount of intake air during deceleration, can be reduced.

As described above, the control apparatus for the internal combustion engine according to this embodiment of the invention actively shifts the opening degree of the throttle valve 25 during the blockage detection to an arbitrary opening degree in the opening direction as to the blockage detection control during deceleration of the vehicle, thus making it possible to detect the blockage at a control point with the highest accuracy in the blockage detection.

Incidentally, in the aforementioned embodiment of the invention, the ECU 60 is configured to detect the change amount in the internal pressure of the intake manifold 21 between the internal pressure detected when the EGR valve 43 is opened and the internal pressure detected when the EGR valve 43 is closed, with the aid of the pressure sensor 64. However, the ECU 60 may detect, by the pressure sensor 64, the change amount in the internal pressure detected by the pressure sensor 64 between the internal pressure detected when the EGR valve 43 is controlled to increase the flow amount of recirculated gas and the internal pressure detected when the EGR valve 43 is controlled to reduce the flow amount of recirculated gas.

As described above, the control apparatus for the internal combustion engine according to the invention has an effect of making it possible to enable the blockage detection at a control point with the highest accuracy in the blockage detection, and is useful as a control apparatus for an internal combustion engine in general as well as a vehicular engine.

1. A control apparatus for an internal combustion engine that includes an intake passage and an exhaust passage, for recirculating part of an exhaust gas discharged to the exhaust passage to the intake passage, the control apparatus comprising:
a throttle valve arranged in the intake passage to regulate an amount of intake air flowing through the intake passage;
an exhaust gas recirculation passage providing fluid communication between the exhaust passage and a region of the intake passage that is located downstream of the throttle valve;
an EGR valve arranged in the exhaust gas recirculation passage to control an amount of exhaust gas recirculated from the exhaust passage to the intake passage;
a pressure sensor configured to detect an internal pressure of the intake passage downstream of a connection portion between the intake passage and the exhaust gas recirculation passage; and
an electronic control unit configured to:
(a) control the EGR valve to modify a flow amount of recirculated gas,
(b) detect a blockage level of the exhaust gas recirculation passage based on a change amount in the internal pressure detected by the pressure sensor, the change amount being a difference between the internal pressure detected when the flow amount of recirculated gas is increased and the internal pressure detected when the flow amount of recirculated gas is reduced,
(c) control the EGR valve at a predetermined time to modify the flow amount of recirculated gas, and to start blockage detection for the exhaust gas recirculation passage, and
(d) increase an opening degree of the throttle valve after start of the blockage detection over an opening degree immediately before the start of the blockage detection.

2. The control apparatus according to claim 1, wherein
the electronic control unit is configured to detect the blockage level of the exhaust gas recirculation passage based on the change amount in the internal pressure detected by the pressure sensor, the change amount is a difference between the internal pressure detected when the EGR valve is opened and the internal pressure detected when the EGR valve is closed.

3. The control apparatus according to claim 1, wherein
the electronic control unit is configured to return the opening degree of the throttle valve to an original value after a lapse of a predetermined time from the start of the blockage detection.

4. The control apparatus according to claim 3, wherein
the electronic control unit is configured to increase the opening degree of the throttle valve in comparison with the opening degree immediately before the start of the blockage detection only during a period in which the EGR valve is open after the start of the blockage detection.

5. The control apparatus according to 1, wherein
the electronic control unit is configured to, at the predetermined time, start the blockage detection independently of opening/closing control of the EGR valve for recirculating exhaust gas from the exhaust passage to the intake passage, the predetermined time occurring when an engine rotational speed of the internal combustion engine reaches a value equal to or lower than a predetermined rotational speed.

6. A control method for a control apparatus including (i) an internal combustion engine having an intake passage, an exhaust passage, a throttle valve, an exhaust gas recirculation passage, and an EGR valve, (ii) a pressure sensor, and (iii) an electronic control unit, wherein
part of an exhaust gas discharged to the exhaust passage is recirculated to the intake passage,
the throttle valve is arranged in the intake passage to regulate an amount of intake air flowing through the intake passage,
the exhaust gas recirculation passage provides fluid communication between the exhaust passage and a region of the intake passage that is located downstream of the throttle valve,
the EGR valve is arranged in the exhaust gas recirculation passage to control an amount of exhaust gas recirculated from the exhaust passage to the intake passage, and
the pressure sensor detects an internal pressure of the intake passage downstream of a connection portion between the intake passage and the exhaust gas recirculation passage,
the control method comprising:
(a) controlling, by the electronic control unit, the EGR valve to modify a flow amount of recirculated gas,
(b) detecting, by the electronic control unit, a blockage level of the exhaust gas recirculation passage based on a change amount in the internal pressure detected by the pressure sensor, the change amount being a difference between the internal pressure detected when the flow amount of recirculated gas is increased and the internal pressure detected when the flow amount of recirculated gas is reduced;
(c) controlling, by the electronic control unit, the EGR valve at a predetermined time to modify the flow amount of recirculated gas, and starting blockage detection of the exhaust gas recirculation passage; and
(d) increasing, by the electronic control unit, an opening degree of the throttle valve after start of the blockage detection over an opening degree immediately before the start of the blockage detection.
